(19) United States
(12) Patent Application Publication
(10) Pub. No.: US 2026/0094062 A1
(43) Pub. Date: Apr. 2, 2026

(54) STORAGE MEDIUM

(71) Applicant: TOYOTA JIDOSHA KABUSHIKI KAISHA, Toyota-shi (JP)

(72) Inventor: Atsushi HIGAKI, Tokyo (JP)

(73) Assignee: TOYOTA JIDOSHA KABUSHIKI KAISHA, Toyota-shi (JP)

(21) Appl. No.: 19/261,096

(22) Filed: Jul. 7, 2025

(30) Foreign Application Priority Data
Sep. 27, 2024 (JP) 2024-169335

(51) Int. Cl. G06N 20/00; G06Q 30/015

(52) U.S. Cl. CPC G06N 20/00; G06Q 30/015

(57) ABSTRACT

A storage medium stores a program causes an information processing device to execute an operation including: training a learning model corresponding to each store by machine learning, wherein the program takes store information of a vehicle store and customer information of a customer in a store as inputs, and proposes proposal information of a vehicle to be proposed to a customer among a plurality of vehicles handled in the store, and obtaining proposal information output from the learning model by inputting customer information of a target customer, which is one or more customers satisfying a predetermined condition, from among a plurality of customers in the store into a learning model.

### CROSS-REFERENCE TO RELATED APPLICATION

This application claims priority to Japanese Patent Application No. 2024-169335 filed on Sep. 27, 2024. The disclosure of the above-identified application, including the specification, drawings, and claims, is incorporated by reference herein in its entirety.

### BACKGROUND

### 1. Technical Field

The present disclosure relates to a storage medium.

### 2. Description of Related Art

Conventionally, techniques relating to proposals to customers are known. For example, Japanese Patent No. 6572354 (JP 6572354 B) discloses a sales proposal system for supporting conversations in sales activities.

### SUMMARY

When the conventional sales proposal system is applied to vehicle sales, the situation (such as vehicles and options being handled) may be different among dealers. With a uniform system, it may be difficult to make an appropriate proposal according to the situation of each dealer.

In view of such circumstances, an object of the present disclosure is to improve a technique related to a proposal to a customer.

An aspect of the present disclosure provides a storage medium storing a program that causes an information processing device to execute operations including: training by machine learning a learning model corresponding to each dealer, the learning model receiving as input dealer information on a vehicle dealer and customer information on a customer of the dealer and outputting proposal information on a vehicle among a plurality of vehicles dealt by the dealer to be proposed to the customer; and acquiring the proposal information output from the learning model by inputting to the learning model the customer information on a target customer that is one or more customers that fulfill a predetermined condition and that are specified from among a plurality of customers of the dealer.

According to an embodiment of the present disclosure, a technique related to a proposal to a customer is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to an embodiment of the present disclosure.

FIG. 2 is a flowchart illustrating an operation of the information processing device according to the embodiment of the present disclosure.

### DETAILED DESCRIPTION OF EMBODIMENTS

Hereinafter, an embodiment of the present disclosure will be described. As used herein, “customer at a retailer” refers to a customer who has used a retailer in the past.

### Outline of Embodiment

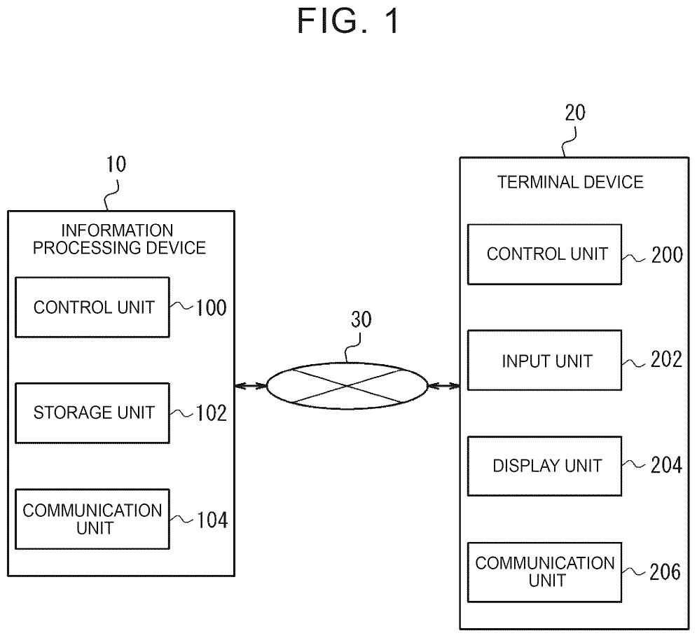

The outline of a system 1 according to one embodiment of the present disclosure will be described with reference to FIG. 1. The system 1 includes an information processing device 10 and a terminal device 20. The information processing device 10 and the terminal device 20 are communicably connected via a network 30 such as the Internet and a mobile communication network.

The information processing device 10 includes one such as a server apparatus or a plurality of computers capable of communicating with each other. The information processing device 10 stores a learning model.

The terminal device 20 is one or more computers such as a PC (Personal Computer), a smart phone, or a tablet. The terminal device 20 is used by, for example, a staff member of a vehicle dealer.

First, the outline of the present embodiment will be described, and the details will be described later. The storage medium according to the present embodiment stores a program that causes the information processing device 10 to execute an operation including training a learning model corresponding to each store by machine learning and acquiring proposal information output from the learning model. The learning model corresponding to each shop inputs the shop information of the vehicle shop and the customer information of the customer in the shop, and outputs the proposal information of the vehicle proposed to the customer among the plurality of vehicles handled by the shop. The proposal information output from the learning model is acquired by inputting, into the learning model, customer information of a target customer who is one or more customers satisfying a predetermined condition, which is specified from among a plurality of customers in the retailer.

According to the present embodiment, proposal information is generated by a learning model trained by using store information unique to each store as an input. Accordingly, appropriate proposal information can be generated in accordance with the situation of the dealer.

### Configuration of the Information Processing Device 10

As illustrated in FIG. 1, the information processing device 10 includes a control unit 100, a storage unit 102, and a communication unit 104.

The control unit 100 may include one or more processors, one or more programmable circuits, one or more dedicated circuits, or a combination thereof. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 100 executes various processes related to the operation of the information processing device 10 and controls each unit of the information processing device 10.

The storage unit 102 includes one or more memories. Each memory included in the storage unit 102 may function as, for example, a main storage device, an auxiliary storage device, or a cache memory. The storage unit 102 stores arbitrary information used for the operation of the information processing device 10. For example, the storage unit 102 may store a system program, an application program, and embedded software. In the present embodiment, the storage unit 102 stores a learning model corresponding to each store. The storage unit 102 may store any information related to the sale of the vehicle. The information stored in the storage unit 102 may be updated, for example, based on information acquired from the network 30 via the communication unit 104.

The communication unit 104 includes at least one communication interface connected to the network 30. The communication interfaces correspond to a mobile communication standard such as 4G (4th generation) or 5G (5th generation), or a wired LAN (Local Area Network) communication standard or a wireless LAN communication standard. However, the communication interface is not limited thereto, and may correspond to any communication standard.

### Configuration of the Terminal Device 20

As illustrated in FIG. 1, the terminal device 20 includes a control unit 200, an input unit 202, a display unit 204, and a communication unit 206.

The control unit 200 may include one or more processors, one or more programmable circuits, one or more dedicated circuits, or a combination thereof. The processor is a general-purpose processor such as a CPU or a GPU, or a dedicated processor specialized for a specific process, for example. However, the processor is not limited to these. The programmable circuit is, for example, an FPGA, but is not limited to this. The dedicated circuit is, for example, an ASIC, but is not limited to this. The control unit 200 executes various processes related to the operation of the terminal device 20 and controls each unit of the terminal device 20.

The input unit 202 includes one or more input interfaces. The input unit 202 receives an operation of inputting information used for the operation of the terminal device 20. The input interface may be, for example, a physical key, a capacitive key, a pointing device, a touch screen integrally provided with a display of the display unit 204, or a microphone that receives an audio input. Instead of being provided in the terminal device 20, the input unit 202 may be connected to the terminal device 20 as an external input device. As the connecting method, any method such as USB (Universal Serial Bus), HDMI (registered trademark) (High-Definition Multimedia Interface), or Bluetooth (registered trademark) can be used.

The display unit 204 includes one or more display interfaces. The display interface is, for example, a display that displays information as an image. Displays are, for example, LCD (Liquid Crystal Display) or organic EL (Electro Luminescence) displays. The display unit 204 displays information obtained by the operation of the terminal device 20. Instead of being provided in the terminal device 20, the display unit 204 may be connected to the terminal device 20 as an external display device. As the connecting method, any method such as USB, HDMI (registered trademark) or Bluetooth (registered trademark) can be used.

The communication unit 206 includes at least one communication interface connected to the network 30. The communication interfaces correspond to, for example, a mobile communication standard such as 4G or 5G, or a wired LAN communication standard or a wireless LAN communication standard, but are not limited thereto, and may correspond to any communication standard.

### Operation Flow of the Information Processing Device 10

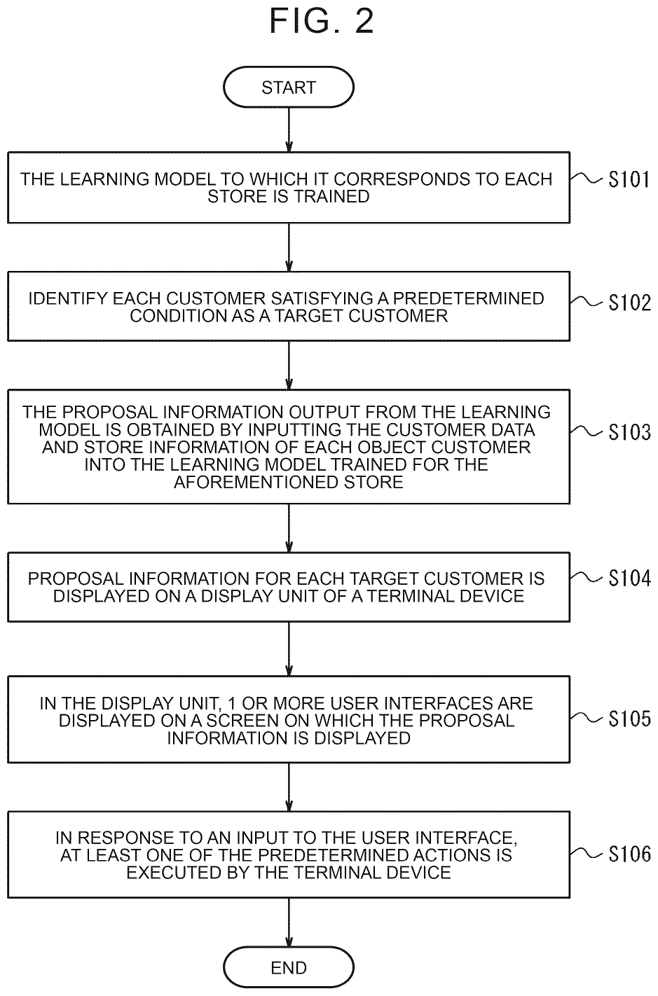

An operation of the information processing device 10 according to the present embodiment will be described with reference to FIG. 2. In the following, communication between the terminal device 20 and the information processing device 10 is performed via the communication units 104 and 206 and the network 30.

S101: The control unit 100 of the information processing device 10 trains a learning model corresponding to each store by machine learning. The learning model corresponding to each shop inputs the shop information of the vehicle shop and the customer information of the customer in the shop, and outputs the proposal information of the vehicle proposed to the customer among the plurality of vehicles handled by the shop. That is, in the information processing device 10, a different learning model is generated for each store.

The shop information may include information indicating one or more of options and a fee plan, such as a vehicle, equipment of the vehicle, and the like handled by the shop. The shop information may further include information indicating a delivery date and an inventory state of each vehicle handled by the shop. By the machine learning that takes the delivery date and inventory of each vehicle as input, it is possible to make a proposal in consideration of the situation of a dealer that preferentially proposes a vehicle with an early delivery date and a vehicle with a remaining inventory. The information of the vehicle handled by the dealer may include one or more of a vehicle type, a grade, specification information, an exhaust amount, a fuel consumption, a drive system (front wheel drive, rear wheel drive, and the like), and a residual value ratio.

The customer information includes primary information and secondary information. The primary information includes current vehicle information indicating information of a current vehicle that is a vehicle currently owned by the customer, and contract information at the time of purchase of the current vehicle. The current vehicle information may include one or more of a vehicle type, a grade, equipment, a travel distance, a vehicle number, a first registration date, a next inspection date, a next inspection date, a remaining price rate, and a trade-in price. The contract information may include one or more of a payment method of a fee for a past vehicle that is a vehicle owned by the current vehicle or the customer in the past, a down payment, a monthly loan payment amount, a loan bonus amount, a remaining amount of money, a number of loans, a subscribing insurance company, a monthly amount or annual amount of insurance, a grade of insurance, a name, an address, and a telephone number. Payment method of the fare of the past car includes residual value setting type loan, split pay, car lease, car subscription, collective pay, etc. “Remaining price-setting loan” means a payment method in which, among purchase prices of vehicles selected by a customer, a pre-set trade-in guarantee price is deferred as a residual value, and the remaining amount is paid in installments in a fixed contract period. The secondary information includes personal information of the customer. The personal information may include one or more of a budget, a number of family members, a family composition, a child's age, a child's current status, pet presence or absence, hobby, a customer's status, a plan to transfer or move, dissatisfaction or desire to a current car, an application of the current car, and a purchasing trend. Current status of children includes birth, admission, club life, etc. The dissatisfaction or desire for the current vehicle includes the desire for the amount of the vehicle, the small rotation, the horsepower, the fuel consumption, the equipment, the amount of the loan, the time and effort required to possess the current vehicle, the maintenance cost, and the like. Applications of the present vehicle include commuting, leisure, and the like. The personal information may be a report that summarizes items previously heard from the customer by the staff in a natural language, for example. Among the customer information input to the learning model, a plurality of feature amounts (budget, lifestyle, dissatisfaction with the current vehicle, and the like) associated with the secondary information are extracted by, for example, natural language processing and used for training the learning model. The extracted feature amount may be set in advance.

The proposal information may include one or more of information of the proposed vehicle, a fee for each payment method, a proposal type, information extracted from the secondary information, and a recommendation sentence generated by the recommendation sentence generation. The proposed vehicle information includes vehicle type, engine type, grade, performance, etc. The fees for each payment method include monthly expenses, etc. The proposal type includes an increase in the size of the vehicle and the like. The information extracted from the secondary information includes “a recent child has been born” and the like. The recommendation generated by the recommendation generation includes, for example, “the customer has a large number of families and the amount of baggage has increased, so it is best to use ◯◯ cars in a large space.” The recommendation may include a sentence including a reason for considering the life of the customer. The recommendation may include a sentence describing a merit (such as a decrease in cost or a trip by all family members) among lifestyle changes that occur when the user purchases the proposed vehicle. For example, as a suggestion, “Monthly amount: If you take out the current car for 0.6 million yen, the monthly amount will not change. ⋅Fuel efficiency: It is used for commuting, and it is 2000 km for the month, so it is economical to reduce the fuel cost by ◯◯0000 yen per year for this car in HEV (Hybrid Electric Vehicle) . . . . ⋅Maintenance: By switching to another car, you can reduce the maintenance cost of the car because it eliminates the need to pay for tire Text such as the above is displayed.

In the present embodiment, the control unit 100 trains the learning model to be a learning model for each store by supervised learning. In the supervised learning, when training the learning model, a case where the learning model outputs the vehicle information of the completed vehicle with the customer related to the customer information input to the learning model is regarded as a correct answer, and a case where the learning model outputs the vehicle information of the vehicle that has not been completed is regarded as an incorrect answer. By adopting the past achievements as teacher data, it is possible to propose a vehicle that is highly likely to be concluded. The control unit 100 may train the learning model by unsupervised learning.

S102: The control unit 100 identifies, as the target customer, one or more customers that satisfy a predetermined criterion from among a plurality of customers in the retail store.

The control unit 100 acquires information indicating a predetermined condition input to the input unit 202 of the terminal device 20 via the communication unit 104. The control unit 100 identifies one or more customers that satisfy the input predetermined condition as target customers. The predetermined condition may include a condition indicating at least one of a customer who is scheduled to visit the retailer, a customer whose remaining period until the expiration date of the car inspection is less than the threshold, and a customer whose predetermined period has elapsed since the initial registration date. As a result, for example, only a customer who needs to deal with a customer in the near future is identified as a target customer, and thus the information list and convenience for the staff are improved.

S103: The control unit 100 acquires the proposal information outputted from the learning model by inputting the customer information and the store information of the target customers to the learning model trained for the store.

The control unit 100 acquires the customer information and the store information of each target customer input to the input unit 202 of the terminal device 20 via the communication unit 104. The control unit 100 acquires the proposal information output from the learning model by inputting the acquired customer information and the store information into the learning model. When generating the proposal information, the learning model may execute the proposal pattern selection, the body type selection, the engine type selection, the vehicle type selection, the payment plan selection, the amount calculation, the recommendation reason generation of the proposed vehicle, and the recommendation sentence generation in this order. The proposed pattern includes scale-up, scale-down, etc. Body types include sedans, minivans, and the like. Engine types include HEV, diesel, etc. Payment plans include lump-sum payments, installment payments, etc.

S104: The control unit 100 causes the display unit 204 of the terminal device 20 to display the proposal data for the target customers.

S105: The control unit 100 causes the display unit 204 to display one or more user interfaces on the screen on which the suggestion information is displayed.

The user interface includes, for example, a button for receiving an input for causing the terminal device 20 to execute a predetermined action. The predetermined action may include generating the estimated information of the vehicle related to the proposal information, printing the proposal, and sending the proposal to the target customer. Here, the proposal document is a document for the customer created based on the proposal information.

S106: The control unit 100 causes the terminal device 20 to execute at least one of predetermined actions in response to inputting to one or more user interfaces.

Since the action can be executed from the screen on which the proposal information is displayed, the transition to another screen becomes unnecessary, and the operability is improved.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 10 and/or the terminal device 20 may be distributed among a plurality of computers capable of communicating with each other. Further, in the above-described embodiment, the terminal device 20 may include a storage unit that stores the above-described learning model, and the control unit 200 of the terminal device 20 may execute the operation of the above-described information processing device 10.

The control unit 100 may further select one or more staff members from among a plurality of staff members of the dealer. The predetermined condition may further include a condition indicating that each of the selected one or more staff members is a customer in charge of customer correspondence, and a condition indicating that each of the selected one or more staff members is a customer in charge of customer correspondence within a predetermined period of time. Since the selected staff is assigned and, for example, only the customer who needs to deal with the customer in the near-term is identified as the target customer for creating the proposal information, the check and management of the schedule of the staff is facilitated for the store manager or the supervisor.

What is claimed is:

1. A non-transitory storage medium storing a program that causes an information processing device to execute operations comprising:
training by machine learning a learning model corresponding to each dealer, the learning model receiving as input dealer information on a vehicle dealer and customer information on a customer of the dealer and outputting proposal information on a vehicle among a plurality of vehicles dealt by the dealer to be proposed to the customer; and
acquiring the proposal information output from the learning model by inputting to the learning model the customer information on a target customer that is one or more customers that fulfill a predetermined condition and that are specified from among a plurality of customers of the dealer.

2. The non-transitory storage medium according to claim 1, wherein the predetermined condition includes at least one of being a customer that has made a reservation to visit the dealer, being a customer that has a vehicle whose remaining period of vehicle inspection certification is less than a threshold, and being a customer that has a vehicle whose month and year of first registration is a predetermined period of time ago.

3. The non-transitory storage medium according to claim 2, wherein:
the operations further include selecting one or more staff members from among a plurality of staff members at the dealer; and
the predetermined condition further includes being a customer to be handled by each of the one or more selected staff members, and being a customer expected to be handled within a predetermined period of time.

4. The non-transitory storage medium according to claim 1, wherein the training includes training the learning model by supervised learning in which a case where the learning model outputs vehicle information on a vehicle purchased by the customer related to the customer information input to the learning model is a correct answer, and a case where the learning model outputs vehicle information on a vehicle not purchased by the customer is an incorrect answer.

5. The non-transitory storage medium according to claim 1, wherein the operations further include:
causing a display unit of a terminal device at the vehicle dealer to display the proposal information for each target customer;
causing the display unit to display one or more user interfaces on a screen on which the proposal information is displayed; and
in response to input to the one or more user interfaces, causing the terminal device to execute at least one of generation of quotation information on the vehicle related to the proposal information, printing of a proposal document that is a document for the customer prepared based on the proposal information, and transmission of the proposal document to the target customer.
